(19) United States
(12) Patent Application Publication
(10) Pub. No.: US 2014/0260643 A1
(43) Pub. Date: Sep. 18, 2014

(54) System for detecting spike killed railroad ties

(71) Applicant: Douglas Delmonico, Broomfield, CO (US)

(72) Inventor: Douglas Delmonico, Broomfield, CO (US)

(21) Appl. No.: 13/815,832

(22) Filed: Mar. 15, 2013

(51) Int. Cl. G01N 3/08

(52) U.S. Cl. CPC G01N 3/08
USPC 73/662; 73/786

(57) ABSTRACT

A system for detecting a spike killed cross-tie comprising a magnet positioned over a railroad fastener. The magnet has a pull force that is at least about 50 lbs, but less than the holding force of a railroad fastener in an undamaged cross-tie or less than about 6,000 lbs.

### BACKGROUND OF THE INVENTION

The present invention relates to railroad equipment for “maintenance of way” operations and, in particular, to equipment for the automated detection of spike killed cross-ties and extraction of railroad spikes.

Railroad track generally consists of two parallel steel rails that are supported on a series of wooden sleepers or cross-ties that are perpendicular to the rails. The rails are fastened to the cross-ties through tie plates to maintain the track gauge or spacing of the two rails. Tie plates generally comprise a flat steel plate with a substantially flat bottom that rests on the cross-tie and distributes the axle load over a wider area. The upper surface of the tie plate has either one or a pair of parallel, vertically projecting ribs or shoulders that define a cradle area or rail seat for receiving the rail. The rail is commonly secured to the cross-tie by a clip or clamp mechanism, but may also be fastened by spikes, screws or bolts driven into the cross-tie through holes in the tie plate. The spike or other fastener has an offset head that serves to secure the rail to tie plate. The tie plate is similarly fastened to the cross-tie by spikes, screws or bolts driven into the cross-tie through holes in the plate that are located on either side of the rail seat.

Over time, with exposure to the elements, cross-ties may become worn or deteriorate to the point where the spikes are only weakly held in the tie and are no longer capable of securing the tie plate and rail from shifting laterally or lifting from the cross-tie. Such cross-ties are referred to as “spike killed” ties. For example, increased axle loads from train traffic exerts repeated lateral and longitudinal forces on the wooden cross-ties that can cause the spike holes to elongate and/or widen out. The repeated axle loads can also cause “crushed rail seat” where the wood fibers beneath the tie plate break down to the point where the cross-tie can no longer hold the spike. Seasonal wet/dry and freeze/thaw cycles can cause the cross-tie to develop splits, which progress and widen over time until the tie can no longer hold the spikes. Fungal decay can also break down exposed wood fibers to the point where the cross-tie can no longer hold the spike. In addition, cross-ties can become broken, damaged or burned during the course of service, which may contribute to spike kill.

The identification and repair of spike killed cross-ties is a significant component of railroad maintenance of way operations. The Federal Railroad Administration (FRA) establishes track safety standards, including the minimum safety requirements relating to cross-ties. Under FRA §213.109, defective cross-ties are defined as including ties that are “impaired to the extent that the crossties . . . will not hold spikes or rail fasteners” and that are “so deteriorated that the tie plate or base of rail can move laterally more than ½ inch relative to the crosstie”.

Once identified, spike killed ties are commonly repaired by inserting a wooden plug into the spike hole of the damaged cross-tie or by filling the spike hole with a resin. Automated spike puller equipment for hydraulic extraction of railroad spikes, and tie plugger equipment for filling spike holes are well known in the art.

Although many of the railroad “maintenance of way” operations have been automated, the identification of spike killed cross-ties is conducted by visual inspection and relies solely on the experience of the inspector. This process is time consuming, costly in terms of personnel and decreased track time, and also requires training of inspectors to consistently identify the spike killed ties. In addition, visual inspection often cannot detect sheared or broken spikes, which may present a greater danger of contributing to derailments. Thus it would be desirable to provide a method and apparatus for automated detection of spike killed cross-ties and sheared or broken spikes, and for the coordinated extraction of the railroad spike and plugging of the spike kill hole.

### SUMMARY OF THE INVENTION

A system for detecting spike killed cross-ties in a railroad track is disclosed. The railroad track includes a rail supported on a tie plate fastened to the cross-tie by a ferromagnetic fastener driven through the tie plate and into the cross-tie. In one embodiment, the system comprises a magnet positioned above the fastener and having a surface for magnetically engaging the fastener, the magnet having a pull force on the fastener of at least about 50 lbs.

A method for detecting a spike killed cross-tie in a railroad track is also disclosed. The fastener has a head that projects above the tie plate. In one embodiment, the method comprises the steps of providing a magnet having a surface for magnetically engaging the fastener, the magnet having a pull force on the fastener of at least about 50 lbs; positioning the surface of the magnet about 2 inches above the head of the fastener; and detecting a spike killed cross-tie by the magnetic attachment of the fastener to the surface of the magnet.

### BRIEF DESCRIPTION OF THE DRAWINGS

FIG. 1 shows a vertical section view of a railroad track and system for detecting a spike killed cross-tie.

FIG. 2 shows a side view of the railroad track and system of FIG. 1.

FIG. 3 shows a vertical section view according to FIG. 1, and depicts the detection of a spike killed cross-tie and extraction of the fasteners.

FIG. 4 shows a side view according to FIG. 2, and depicts the detection of a spike killed cross-tie and extraction of one of the two fasteners

### DETAILED DESCRIPTION OF THE INVENTION

Referring to FIGS. 1 and 2, a system for automated detection of spike killed cross-ties in a railroad track is shown. The railroad track consists of a rail 10 supported on a tie plate 12 that is fastened to a sleeper or cross-tie 14 by fasteners 16, 18 and 20, which are driven through tie plate 12 and into cross-tie 14. Each fastener has a head (e.g., head 17 of fastener 16) that projects above tie plate 12 and serves to secure the tie plate and rail 10 to cross-tie 14. As shown in FIGS. 1 and 2, the fasteners are conventional railroad spikes. However, fasteners 16, 18 and 20 may also be screws, bolts or other fasteners known in the art. Such fasteners are conventionally made of ferromagnetic materials such as steel and other iron alloys.

Referring to FIG. 1, a system for detecting spike killed cross-ties comprises a magnet 22 that is positioned to one side of the rail 10 and above fastener 16 in tie plate 12. Magnet 22 has a contact surface 24 for magnetically engaging fastener 16. In a preferred embodiment, magnet 22 is positioned so that contact surface 24 has a height h of about 1 inch to about 3 inches above the head 17 of fastener 16, more preferably between about 2 inches to about 3 inches above the head of the fastener, and most preferably about 2 inches above the head of the fastener.

Those of skill in the art will appreciate that the pull force of magnet 22 is a function of the distance of the magnet from the fastener. In a preferred embodiment, magnet 22 has a pull force that is at least equivalent to that exerted manually using spike pulling tools such as a claw bar—e.g., a pull force of at least about 50 lbs. It is further preferred that magnet 22 has a pull force that is less than the holding force of a railroad spike in an undamaged cross-tie. In the case of hardwood cross ties (e.g., oak or douglas fir), the spike holding force is about 6,000 lbs to 10,000 lbs. Thus, in a particularly preferred embodiment, magnet 22 has a pull force of between about 50 lbs to about 1,000 lbs, and more preferably between about 50 lbs to about 200 lbs.

Those of skill in the art will also appreciate that the size of magnet 22 is a function of the required pull force, and that the magnet has a shape that does not interfere with its access to and engagement of the fasteners in the railroad track. In a preferred embodiment, magnet 22 is sized and shaped to have a contact surface 24 that is generally larger than the head of the fastener (e.g., magnet surface 24 and fastener head 17 shown in FIG. 16).

In the case where tie plate 12 and rail 10 are fastened to cross-tie 14 by two fasteners that are located on the same side of rail 10 (e.g., fasteners 16 and 18), it is further preferred that magnet 22 is sized and shaped to have a contact surface 24 that extends above both fasteners, as shown in FIG. 2. This permits simultaneous detection of a spike killed cross-tie with respect to both fasteners. In a particularly preferred embodiment, magnet 22 has a rectangular contact surface 24 with a width (perpendicular to the rail) of about 3 inches and a length (parallel to the rail) of about 8 inches. These dimensions generally provide a contact surface having a width that is larger than the head of a standard railroad spike and a length that is roughly the same or larger than the width of a conventional tie plate.

Magnet 22 may be a permanent magnet or an electromagnet. It is presently preferred to use a permanent magnet, which does not require a constant source of power. Suitable permanent magnets include rare earth magnets (e.g., Neodymium Iron Boron and Samarium Cobalt magnets), Alnico (Aluminum, Nickel and Cobalt) magnets and ceramic or ferrite magnets, as are known in the art. However, electromagnets are advantageous in that the pull force is variable and the magnet may be turned off and on by regulating the current.

In practice, magnet 22 is positioned over fastener 16 (and/or 18). Spike killed cross-ties are automatically detected where the pull force of the magnet is sufficient to extract the relatively weakly held fastener from the spike killed tie, and the fastener pops up out of cross-tie 14 and attaches to the contact surface 24. Attachment of a fastener to the magnet can readily be confirmed visually (and aurally), without the need for trained visual inspection. The present system is also capable of detecting fasteners that are sheared or broken below the surface of the tie plate and that may otherwise be undetectable by conventional visual inspection. Because magnet 22 has a pull force less than 6,000 lbs, fasteners in non-spike killed cross-ties will remain unaffected.

In an alternative embodiment, magnet 22 may be coupled to a vertical positioner for raising and lowering the magnet. Suitable vertical positioners include hydraulic cylinders and other mechanical actuators that are well known in the art.

After a spike killed cross-tie is detected, the vertical positioner may be actuated to raise magnet 22 relative to tie plate 12 and lift the attached fastener (e.g., fasteners 16 and 18) free of the tie plate and cross-tie 14. The attached fastener is then released and the vertical positioner is again actuated to lower magnet 22 into position for detection of another spike killed cross-tie. In the case of an electromagnet, the attached fastener may be released by turning off the current to the electromagnet. In the case of a permanent magnet, release of an attached fastener may be facilitated by an arm moveable over contact surface 24 to dislodge the fastener.

In a further embodiment, magnet 22 may be coupled to the frame of a vehicle or railroad equipment adapted to travel on rails, as are well known in the art. An example of a suitable railroad equipment is described in U.S. patent application Ser. No. 11/999,699 (published Jun. 11, 2009, as Pub. No. US 2009/0145324), which is incorporated herein by reference in its entirety. FIG. 4 is a representation of the association of magnets 22 and 30 with a railroad equipment 32 adapted to travel on rails. Where a vertical positioner is used, the vertical positioner may be secured to the frame of the equipment and magnet 22 is coupled to the vertical positioner for operation as described above. As the equipment travels over the railroad track, magnet 22 passes over the fasteners 16 and 18 of each cross-tie and spike killed ties are rapidly and automatically detected. The railroad equipment may also provide other related maintenance of way functions. For example, automated tie plugging equipment is well known in the art and can be used to repair the identified spike killed cross-ties.

In another embodiment, the system may comprise two magnets. Referring to FIG. 1, tie plate 12 and rail 10 are fastened to cross-tie 14 by fasteners 16 and 20 on either side of rail 10—i.e. by a first fastener 16 on a first side of rail 10 and a second fastener 20 on a second side of rail 10. A first magnet 22 is positioned above fastener 16 and a second magnet 26 is positioned over fastener 20. This configuration allows simultaneous detection with respect to fasteners on both sides of rail 10 (e.g., fasteners 16 and 20). Using four magnets, this configuration may be duplicated on a second rail to allow simultaneous detection on both sides of both rails of a railroad track. Each magnet may be independently coupled to a vertical positioner, or sets of magnets may be coupled to a vertical positioner.

In yet another embodiment, the system may further comprise a vibration device that vibrates the railroad track in the general area of a fastener. Suitable vibration devices include jumping jack type vibratory compactors or tampers, as are known in the art. In general, such devices have a frequency in the range of about 600 vpm to about 700 vpm up to a range of about 1100 vpm to 1300 vpm. In a preferred embodiment, the vibrator is placed on the rail in front of and/or behind the magnet. It is believed that the vibration reduces friction and allows the fastener to be more easily pulled from the spike killed tie.

While various embodiments of a system for detecting a spike killed cross-tie are disclosed, and methods for using the same have been described in considerable detail herein, the embodiments are merely offered by way of non-limiting examples of the disclosure described herein. Many variations and modifications of the embodiments described herein will be apparent to one of ordinary skill in the art in light of this disclosure. It will therefore be understood by those skilled in the art that various changes and modifications may be made, and equivalents may be substituted for elements thereof, without departing from the scope of the disclosure. This disclosure is not intended to be exhaustive or to limit the scope of the disclosure. The scope of the disclosure is to be defined by the appended claims, and by their equivalents. It is therefore intended that the disclosure will include, and this description and the appended claims will encompass, all modifications and changes apparent to those of ordinary skill in the art based on this disclosure.

What is claimed is:

1. A system for detecting a spike killed cross-tie in a railroad track having a tie plate and rail fastened to the cross-tie by a ferromagnetic fastener driven into the cross-tie through the tie plate, the system comprising:
a magnet positioned above the fastener and having a surface for magnetically engaging the fastener, the magnet having a pull force on the fastener of at least about 50 lbs.

2. The system of claim 1, wherein the magnet has a pull force on the fastener in a range of about 50 lbs to about 1000 lbs.

3. The system of claim 1, wherein the magnet has a pull force on the fastener in a range of about 50 lbs to about 200 lbs.

4. The system of claim 1, wherein the fastener has a head that projects above the tie plate, and surface of the magnet is about 2 inches above the head of the fastener.

5. The system of claim 1, wherein the tie plate and rail are fastened to the cross-tie by two fasteners located on the same side of the rail, and the surface of the magnet extends above both fasteners.

6. The system of claim 1, wherein the surface of the magnet is a rectangle having a length parallel to the rail of about 8 inches and a width perpendicular to the rail of about 3 inches.

7. The system of claim 1, further comprising a vertical positioner, the magnet coupled to the vertical positioner for raising and lowering the magnet relative to the tie plate.

8. The system of claim 1, further comprising an arm moveable over the surface of the magnet to facilitate release of a fastener magnetically attached to the surface of the magnet.

9. The system of claim 1, further comprising a vibratory device for vibrating the railroad track in the region of the fastener.

10. The system of claim 1, wherein the magnet is a permanent magnet.

11. The system of claim 1, wherein the magnet is an electromagnet.

12. The system of claim 1, wherein the pull force of the electromagnet is variable.

13. The system of claim 1, wherein the fastener is selected from the group consisting of: a spike, a screw and a bolt.

14. The system of claim 1, wherein the tie plate and rail are fastened to the cross-tie by a ferromagnetic first fastener on a first side of the rail and a ferromagnetic second fastener on a second side of the rail, the system further comprising:
a first magnet positioned above the first fastener and having a surface for magnetically engaging the first fastener; and
a second magnet positioned above the second fastener and having a surface for magnetically engaging the second fastener;
wherein the first and second magnets respectively have a pull force on the first and second fasteners of at least about 50 lbs.

15. The system of claim 1, wherein the railroad track has parallel first and second rails and first and second tie plates respectively fastened to the cross-tie by ferromagnetic first and second fasteners, the system further comprising:
a first magnet positioned above the first fastener and having a surface for magnetically engaging the first fastener; and
a second magnet positioned above the second fastener and having a surface for magnetically engaging the second fastener;
wherein the first and second magnets respectively have a pull force on the first and second fasteners of at least about 50 lbs.

16. The system of claim 1, wherein the railroad track has parallel first and second rails and first and second tie plates, the first tie plate and first rail fastened to the cross-tie by a ferromagnetic first fastener on a first side of the first rail and a ferromagnetic second fastener on a second side of the first rail, the second tie plate and second rail fastened to the cross-tie by a ferromagnetic third fastener on a first side of the second rail and a ferromagnetic fourth fastener on a second side of the second rail, the system further comprising:
a first magnet positioned above the first fastener and having a surface for magnetically engaging the first fastener;
a second magnet positioned above the second fastener and having a surface for magnetically engaging the second fastener;
a third magnet positioned above the third fastener and having a surface for magnetically engaging the third fastener; and
a fourth magnet positioned above the fourth fastener and having a surface for magnetically engaging the fourth fastener; and
wherein the first, second, third and fourth magnets respectively have a pull force on the first, second, third and fourth fasteners of at least about 50 lbs.

17. A system for detecting a spike killed cross-tie in a railroad track having a tie plate and rail fastened to the cross-tie by a ferromagnetic fastener driven through the tie plate and into the cross-tie, the system comprising:
a frame including at least one rail wheel for traveling on the rail;
a magnet coupled to the frame and positioned above the fastener, the magnet having a surface for magnetically engaging the fastener and having a pull force on the fastener of at least about 50 lbs.

18. The system of claim 17, further comprising a vertical positioner secured to the frame, the magnet coupled to the vertical positioner for raising and lowering the magnet relative to the tie plate.

19. The system of claim 18, wherein the vertical positioner is hydraulic.

20. The system of claim 17, wherein the magnet has a pull force on the fastener in a range of about 50 lbs to about 1000 lbs.

21. The system of claim 17, wherein the magnet has a pull force on the fastener in a range of about 50 lbs to about 200 lbs.

22. The system of claim 17, wherein the fastener has a head that projects above the tie plate, and surface of the magnet is about 2 inches above the head of the fastener.

23. A method for detecting a spike killed cross-tie in a railroad track having a tie plate and rail fastened to a cross-tie by a ferromagnetic fastener driven through the tie plate and into the cross-tie, the fastener having a head that projects above the tie plate, the method comprising the steps of:
providing a magnet having a surface for magnetically engaging the fastener, the magnet having a pull force on the fastener of at least about 50 lbs;
positioning the surface of the magnet about 2 inches above the head of the fastener; and
detecting a spike killed cross-tie by the magnetic attachment of the fastener to the surface of the magnet.

24. The method of claim 23, further comprising the steps of:
raising the magnet to remove the attached fastener from the spike killed cross-tie and tie plate; and
releasing the attached fastener from the surface of the magnet.

25. The method of claim 23, wherein the magnet has a pull force on the fastener in a range of about 50 lbs to about 1000 lbs.

26. The method of claim 23, wherein the magnet has a pull force on the fastener in a range of about 50 lbs to about 200 lbs.

27. The method of claim 23, further comprising the step of vibrating the railroad track in the region of the fastener.
